(19) United States
(12) Patent Application Publication
(10) Pub. No.: US 2011/0116274 A1
(43) Pub. Date: May 19, 2011

(54) ACCESSORY SERVING AS DECORATION AND DECORATION SUPPORT FOR LIGHT-EMITTING DIODE (LED) BULB STRING

(76) Inventor: CHANG-FU TSAI, Taichung (TW)

(21) Appl. No.: 12/621,516

(22) Filed: Nov. 19, 2009

(51) Int. Cl. F21V 3/00; F21V 17/06; F21V 5/00

(52) U.S. Cl. 362/311.13; 362/433; 362/311.01

(57) ABSTRACT

An accessory is provided for a light-emitting diode (LED) bulb string. The accessory has a projection portion having a proximal end mounted to a bottom plate and forming a bore for receiving an LED bulb of the bulb string. The bore has a tapering section for securely engaging and thus holding the bulb. The plate has an end remote from the projection portion and forming an end hook for easily engaging and thus mounting the accessory to a Christmas tree. The projection portion has a distal end forming a multiple-facet refraction/diffraction body. The projection portion may serve as a light guide to guide light from the bulb to the distal end thereof and thus the accessory itself may serve as a decoration. The projection portion may be additionally fit into a bore defined in an external, light-transmitting decorative article to support the decorative article at a desired orientation.

### BACKGROUND OF THE INVENTION

1. Field of the Invention

The present invention relates to the field of bulb strings, such as a Christmas tree bulb string, and decorations, such as a Christmas tree decorative article, and in particular to an accessory for light-emitting diode (LED) bulb string, which serves as a decoration for the bulb string and may alternatively play the role of supporting an external decorative article to for example a Christmas tree.

2. The Related Arts

Bulb strings are commonly used to wrap around or set on a top of a Christmas tree and the progress of technology brings about development of light-emitting diodes (LED's), which are gradually replacing the traditional incandescent bulbs. Thus, bulb strings made of LED bulbs are now prevailing around the world. However, no existing products or devices are available for helping spreading and emitting light from LED bulbs in versatile forms for bringing about additional and expanded applications, nor is there any device that facilitates combination of decorations and LED bulbs or that allows manufactures of decorations to make versatile products so that general consumers may acquire these products and devices and assemble their own decorative and lighting articles without causing undesired safety problems. Further, there is no existing design that allows the manufacturers to easily combine an LED bulb in a decorative article without additional costs and efforts, for such a design would allow the manufacturers to save expense of purchase and installation of additional machines.

Thus, it is desired to provide an accessory that overcomes the above discussed problems of the existing products and this is a major challenge for the manufacturers.

### SUMMARY OF THE INVENTION

The problem to be addressed by the present invention is that the existing devices cannot help in versatile emission of light from an LED bulb for bringing about additional peripheral applications, nor is there any device that facilitates combination of decorations and LED bulbs or that allows manufactures of decorations to make versatile products so that general consumers may acquire these products and devices and assemble their own decorative and lighting articles without causing undesired safety problems. Further, there is no existing design that allows the manufacturers to easily combine an LED bulb in a decorative article without additional costs and efforts, for such a design would allow the manufacturers to save expense of purchase and installation of additional machines.

To solve such problems and drawbacks, the present invention provides an accessory that could serve as a decoration and a support for decoration of a light-emitting diode (LED) bulb string. The accessory comprises an elongate projection portion having a proximal end mounted to a bottom plate portion. The proximal end forms a bore having an opening defined in the plate portion for receiving an LED bulb therein. The bore is composed of at least one diameter-decreasing, tapering section. The plate portion is mounted to the projection portion in such a way that a remote end of the plate portion extends away from the projection portion and forms an end hook adapted to engage and thus mount to an external support, such as a leaf of a Christmas tree. The projection portion has a distal end opposite to the plate portion and forming a refraction/diffraction body that comprises a plurality of differently-angled facets. The projection portion can serve as a light guide to guide light emitted from the LED bulb so that the accessory itself can serve as a decoration. The LED, which is so received in the bore, is provided with an increased surface area of light emission by the refraction/diffraction body and additional visual effect. In addition, the projection portion of the accessory is sized and shaped to snugly and preferably slightly tightly fit into a corresponding bore defined in an external decorative article so as to support the external decorative article at a desired orientation. The external decorative article can be made light transmittable so that the light from the LED bulb can be spread by the accessory to uniformly distribute through the external decorative article to make the external decorative article luminous.

The effectiveness of the present invention is that the accessory of the present invention offers excellent capability of assembling, which helps combining an LED bulb in a decorative article, so that the decoration manufacturers may provide versatile decorative products that allow the general consumers to selectively assemble the decorative products with LED bulb to make their own lighting decorations without causing undesired safety problems. Further, the decoration manufacturers do not need to purchase and install additional machines for mounting or embedding an LED bulb in a decorative article, or the design and development of decorations do not need to take the issue of embedding or mounting an LED bulb in the decoration into consideration. This apparently helps lowering the manufacturing costs.

### BRIEF DESCRIPTION OF THE DRAWINGS

The present invention will be apparent to those skilled in the art by reading the following description of a preferred embodiment thereof, with reference to the attached drawings, wherein:

FIG. 1 is a perspective view of an accessory constructed in accordance with an embodiment of the present invention;

FIG. 2 is a perspective view of the accessory of the present invention mounted to a light-emitting diode (LED) bulb of a bulb string;

FIG. 3 is an exploded view showing an accessory in accordance with an embodiment of the present invention to be mounted to a decoration;

FIG. 4 is a perspective view showing the accessory of the present invention mounted to the decoration;

FIG. 5 is a perspective view similar to FIG. 4 but showing the decoration lit by light from an LED bulb;

FIG. 6 is a perspective view illustrating an accessory in accordance with an embodiment of the present invention mounted to a different decoration;

FIG. 7 is a perspective view similar to FIG. 6 but showing the decoration lit by light from an LED bulb;

FIG. 8 is a schematic view showing an accessory in accordance with the present invention mounted to a Christmas tree;

FIG. 9 is a schematic view showing an alternatively-configured LED bulb that is applicable to an accessory in accordance with the present invention; and

FIG. 10 is a schematic view showing a conventional incandescent bulb is not allowed to mount to an accessory of the present invention.

### DETAILED DESCRIPTION OF THE PREFERRED EMBODIMENT

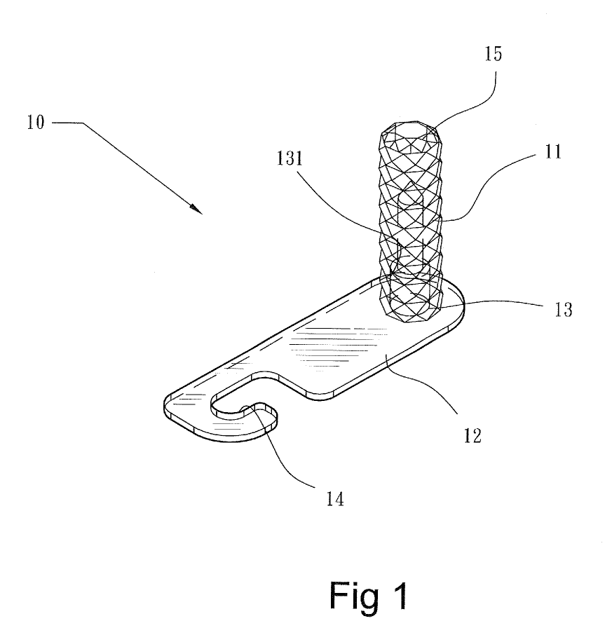

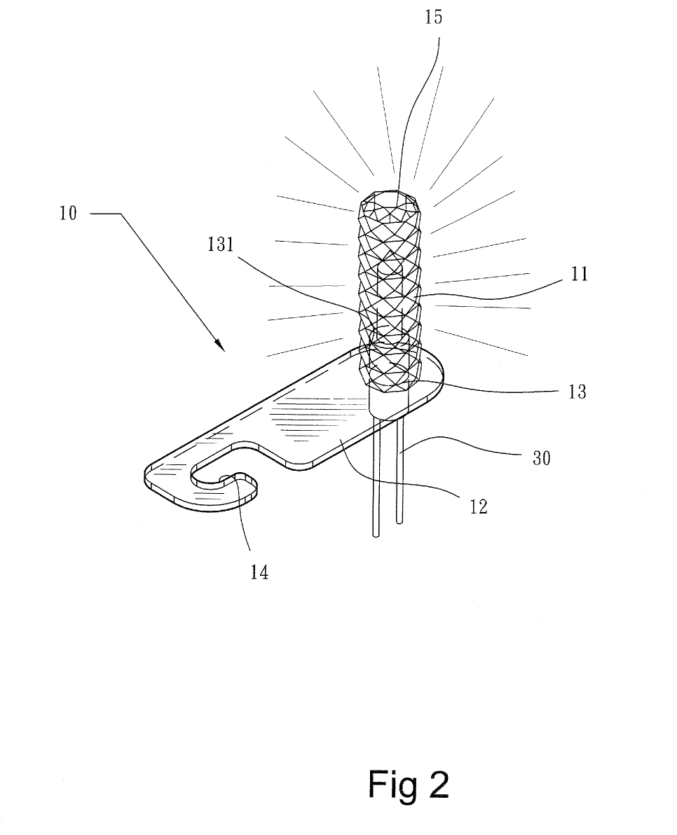

The present invention provides an accessory of a light-emitting diode (LED) bulb string that serves as either a decoration itself for the LED bulb string or a support that couples a decoration to the LED bulb string. For better understanding of the structure and function of the insert in accordance with the present invention, a detailed description of an embodiment of the present invention will be given with reference to FIGS. 1 and 2, which show, respectively, a perspective view of the accessory in accordance with the present invention and a perspective view of the accessory of the present invention mounted to an LED bulb of a bulb string.

In accordance with the embodiment of the present invention shown in FIGS. 1 and 2, the accessory of the present invention, which is generally designated at 10, comprises an elongate cylinder or bar like projection portion 11 that has a proximal end mounted to an elongate strip-like plate portion 12. The proximal end of the projection portion 11 defines a bore 13, which can be formed centrally in the proximal end, but not necessarily so. The bore 13 extends through the plate portion 12 and thus defines an opening in the plate portion 12. The bore 13 can be a blind hole, as illustrated in the drawings, or alternatively and if desired, the bore can be a through hole, and either the blind hole or the through hole is made extending in an axial direction of the projection portion 11. The bore 13 is composed of at least one section 131 and the section 131 has an inside diameter, which is preferably of slight tapering, so that the inside diameter of the opening defined in the plate portion 12 is slightly greater than that at an inner end of the bore 13. In other words, the bore 13 or one section of the bore 13 is a tapering hole converging inwardly. It is noted that the tapering is minute so that it cannot be clearly distinguished in the drawings.

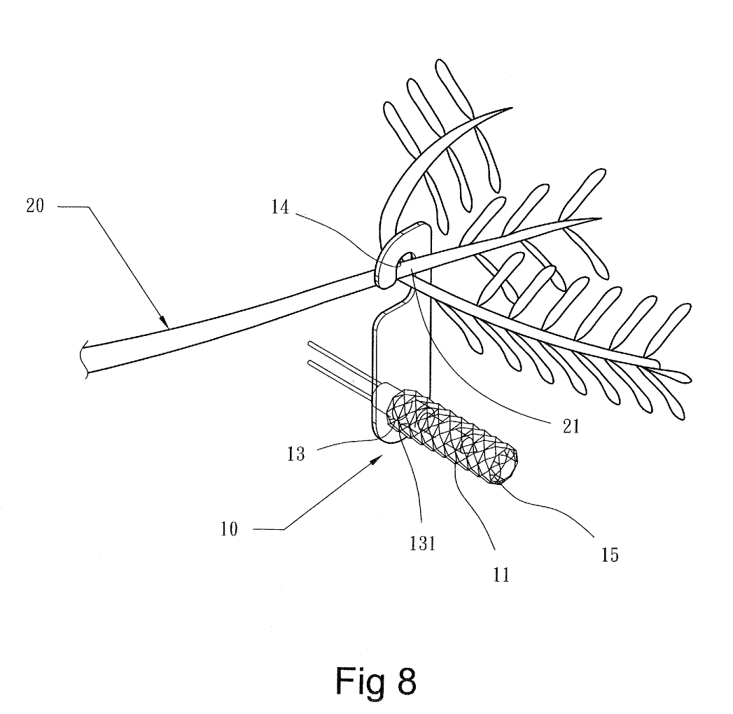

The plate portion 12 is an elongate strip in the embodiment shown and extend in a sideway direction that is preferably perpendicular to or transverse with respect to the axial direction of the projection portion 11, but can be extended in any desired angle with respect to the axial direction. The plate portion 12 has a remote end that is distant from the projection portion 11 and the remote end of the plate portion 12 defines a recess in a side edge thereof to thereby make the remote end a hook like configuration 14. The end hook 14 is thus integrally formed with the plate 12. The end hook 14 allows the plate 12 to be readily mounted to an external article, such as a Christmas tree 20, by fitting the side recess of the plate 12 over a stem of a tree leaf 21, as shown in FIG. 8, thereby engaging the end hook 14 with the tree leaf 21. In this way, the accessory 10 can be easily mounted to the Christmas tree 20.

In accordance with an embodiment of the present invention, the projection portion 11 has a distal end opposite to the bored proximal end, and the distal end is formed to show a cut gemstone like configuration, namely having a plurality of differently angled facets that collectively define a multiple-angled light refraction/diffraction body 15. The projection portion 11 is preferably made of a light conduction material so that the projection portion 11 may guide the transmission of light therethrough to the refraction/diffraction body 15 of the distal end thereof. With such an arrangement, the projection portion 11 itself can serve as a decoration. The accessory 10 is put into use by fitting an LED bulb 30 of an LED bulb string into the bore 13 through the opening defined in the plate 12 and the bulb 30 is securely held in position in the bore 13 by the tapering bore section 131 due to a slight force fitting formed therebetween. The multiple facets of the refraction/diffraction body 15 of the projection portion 11 so fit over the bulb 30 provides an enlarged surface area for light emission and thus enhances visual effect of the bulb 30.

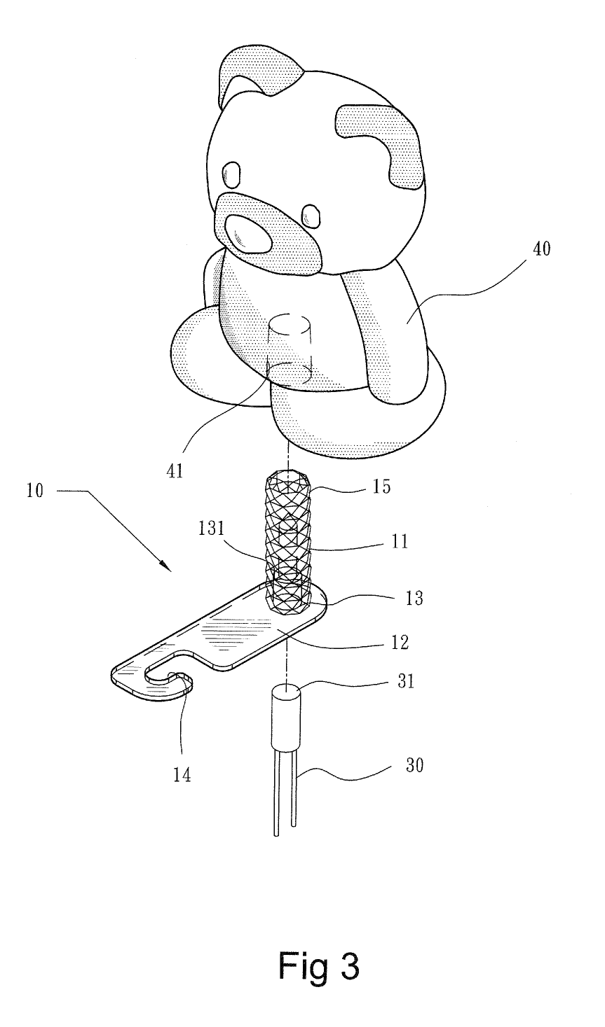

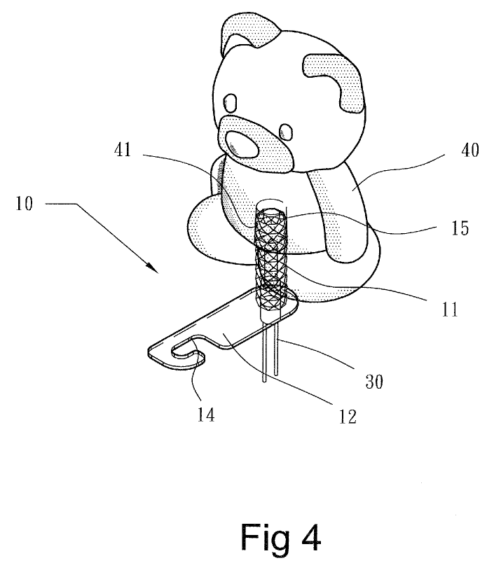

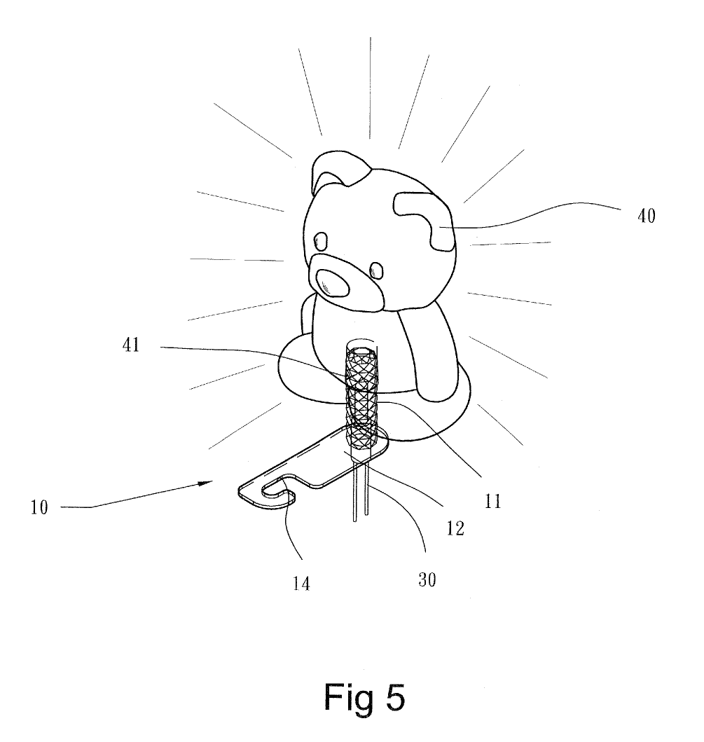

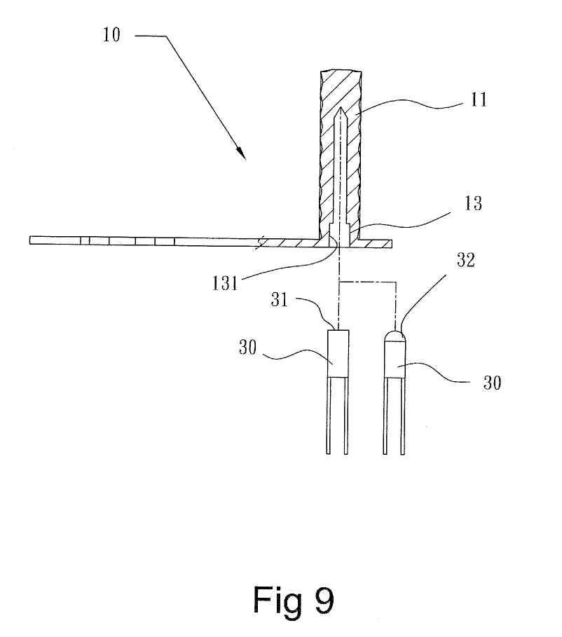

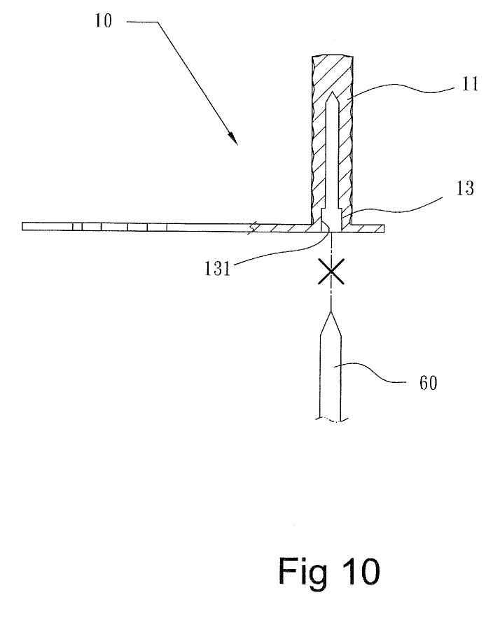

In an alternative application of the accessory of the present invention, the accessory serves as a support for a decoration of an LED bulb string. In this respect, the projection portion 12 has an outer shape that corresponds to and is fit into a bore defined in the decoration whereby when the accessory 10 is mounted to for example the Christmas tree 20, the accessory 10 securely supports the decoration on the Christmas tree. Another embodiment of the present invention that demonstrates said alternative application of the accessory is illustrated in FIGS. 3-5. As shown in FIGS. 3-5, and similar to the embodiment discussed with reference to FIGS. 1 and 2, an accessory 10 is composed of a projection portion 11 has a proximal end mounted to a plate 12. The projection portion 11 defines, in the proximal end, a bore 13 that is composed of at least one slightly tapering section 131. The plate 12 has a remote end that is distant from the projection portion 11 and forms an end hook 14. The projection portion 11 has a distal end forming a multiple-facet light refraction/diffraction body 15 and the projection portion 11 serves as a light guide that guides light from an LED bulb 30 fit into the bore 13 to the light refraction/diffraction body 15. The LED bulb 30 can be of a flat top end 31 (see FIG. 3) or a rounded top end 32 (see FIG. 9) and both types of top end allow the bulb 30 to be readily fit into the bore 13. The bulb 30 is secured in position by the tight engagement between the bulb 30 and the tapering section 131 of the bore 13. Further, the tapering section 131 also serves to prevent a conventional or regular incandescent bulb 60 (see FIG. 10) from being mistakenly fit into the bore 13. The multiple facets of the refraction/diffraction body 15 of the projection portion 11 so fit over the bulb 30 provides an enlarged surface area for light emission and enhances visual effect of the bulb 30.

The projection portion 11 is shaped to allow for direct insertion into a corresponding bore defined in a decoration, such as a bear-figured decoration 40. The decoration 40 has a bottom in which a bore 41 corresponding to the shape of the projection portion 11 is defined to allow for the direct insertion of the projection portion 11 therein. The accessory 10 of the present invention, with the projection portion 11 thereof properly fit into the bore 41 of the decoration 40, helps to maintain the decoration 40 at a desired orientation, such as upright, without undesired inclination. For example, the accessory 10 is mounted to the Christmas tree and thus supports the decoration 40 on the tree in a desired orientation. It is evident that the plate 12 can be set at any desired angle with respect to the axial direction of the projection portion 11 and this allows the decoration 40 to be supported at any desired orientation.

The decoration 40 can be of made of a light transmitting material whereby the light from the bulb 30 and emitted through the accessory 10 can be spread through the whole decoration 40 or, if desired, a portion of the decoration 40. The decoration 40 can thus be lit.

As mentioned above, the accessory 10 of the present invention defines a bore 13 for receiving an LED bulb 30 and the bore 13 is composed of at least one tapering section 131. The tapering section 131 serves to securely hold the bulb 30 in position inside the bore 13 and also provides a fool-proof function that prevents a conventional incandescent bulb 60 (see FIG. 10) from being mistakenly inserted into the bore 13. This makes the prevent invention complying with child toy safety regulation and offers safety in the application and operation thereof.

The bore 13 of the accessory 10 is shaped and sized to allow for insertion of an LED bulb 30 therein in a slightly forced manner and a slightly tight engagement is established therebetween to hold the bulb 30 in position. Such a slightly tight engagement also allows for easy removal of the bulb 30 from the bore 13 by applying a slight force thereto. No jamming of the bulb 30 in the bore 13 may occur and flexibility in use and application of the present invention can be realized.

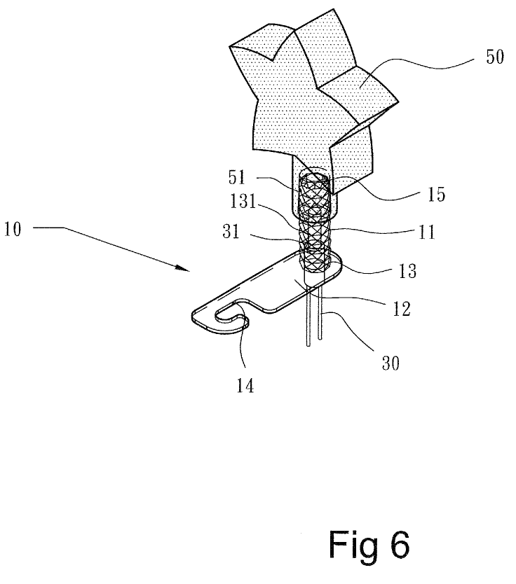

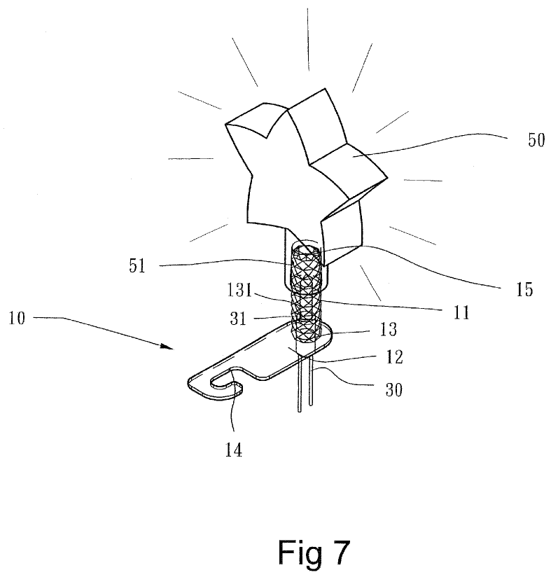

Referring to FIGS. 6 and 7, an illustration of a further application of the accessory 10 of the present invention will be described. Similar to what described previously, the accessory 10 is composed of a projection portion 11 has a proximal end mounted to a plate 12. The projection portion 11 defines, in the proximal end, a bore 13 that is composed of at least one slightly tapering section 131. The plate 12 has a remote end that is distant from the projection portion 11 and forms an end hook 14. The projection portion 11 has a distal end forming a multiple-facet light refraction/diffraction body 15 and the projection portion 11 serves as a light guide that guides light from an LED bulb 30 fit into the bore 13 to the light refraction/diffraction body 15. The LED bulb 30 can be of a flat top end 31 (see FIGS. 6 and 7) or a rounded top end 32 (see FIG. 9) and has a cylindrical outer circumference that is slightly tightly fit in the tapering section 1313 of the bore 13. The multiple facets of the refraction/diffraction body 15 of the projection portion 11 so fit over the bulb 30 provides an enlarged surface area for light emission and enhances visual effect of the bulb 30. The projection portion 11 is shaped for direct insertion into a corresponding bore defined in a decoration, such as a star-shaped decoration 50. The decoration 50 has a bottom portion in which a bore 51 corresponding to the shape of the projection portion 11 is defined to allow for the direct insertion of the projection portion 11 therein. The accessory 10 of the present invention, with the projection portion 11 thereof properly fit into the bore 51 of the decoration 50, helps to maintain the decoration 50 at a desired orientation, such as upright, without undesired inclination.

The efficacy of the present invention is as follows:

(1) The present invention provides a novel structure of an accessory that could serve as a decoration or a support for decoration of an LED bulb string. The accessory comprises a projection portion that serves as a light guide so that the accessory itself can serve as a decoration. The accessory helps to increase the surface area for emission of light when the accessory is fit to an LED bulb and also provides a pleasing visual effect. The projection portion of the accessory can be alternatively fit into a bore defined in an external decorative article to help supporting the decorative article in a desired orientation without undesired inclination. For a decorative article that allows for light transmission therethrough, the accessory that carries an LED bulb, when fit into the bore of the decorative article, allows the light from the bulb to spread through the decorative article. The accessory provides excellent and ready coupling with an external decorative article and helps coupling the decorative article to the LED bulb, thereby allowing manufacturers to make products of versatile variations and also allowing general consumers to do product assembling by themselves without causing any safety related concerns. In addition, the manufacturers of decorative articles does not need to set up machinery for setting an LED bulb inside a decorative article, neither it needs to take the arrangement of an LED bulb inside a decoration into consideration in designing the decoration. This certainly helps reducing the costs of these products.

(2) The present invention provides an accessory for an LED bulb string, which comprises an elongate projection portion serving as a light guide thereby making the accessory itself a decoration. The projection portion forms a bore that is composed of at least one tapering section for preventing mistaken insertion of a regular incandescent bulb into the accessory for the conventional incandescent bulb has a conic tip that is not fit for the tapering section of the bore. This provides a fool-proof function, so that the present invention complies with child toy safety regulation and offers safety of operation and use.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. An accessory adapted to use with a light-emitting diode (LED) bulb, comprising:
a projection portion having a first end forming a bore that is adapted to receive the LED bulb therein, the projection portion serving as a light guide to guide light emitted from the LED bulb; and
a plate portion, to which the first end of the projection portion is mounted and which forms an opening of the bore of the projection portion for receiving entry of the LED bulb into the bore, the plate portion having a remote end extending away from the projection portion and forming an end hook adapted to engage and thus mount to an external support.

2. The accessory as claimed in claim 1, wherein the projection portion has a second end opposite to the plate portion and forming a refraction/diffraction body that comprises a plurality of differently-angled facets to increase surface area for light emission.

3. The accessory as claimed in claim 1, wherein the bore of the projection portion comprises at least one tapering section of which an inside diameter is converged to provide a slightly engagement with the LED bulb received in the bore so as to securely hold the bulb in position but still allow the bulb to be removed out of the bore.

4. The accessory as claimed in claim 1 further comprising a decoration that defines a bore sized to receive the projection portion to fit into the bore so as to support the decoration at a desired orientation.

5. The accessory as claimed in claim 4, wherein the projection portion is in the form of a cylinder to be fit into a correspondingly shaped bore defined in the decoration.
